(19) United States
(12) Patent Application Publication
(10) Pub. No.: US 2026/0302366 A1
(43) Pub. Date: Oct. 1, 2026

(54) ALL-SOLID-STATE BATTERY AND METHOD OF MANUFACTURING ALL-SOLID-STATE BATTERY

(71) Applicant: HONDA MOTOR CO., LTD., Tokyo (JP)

(72) Inventors: Kizashi IWAKIRI, Saitama (JP); Takuya TANIUCHI, Saitama (JP); Toshimitsu TANAKA, Saitama (JP); Kiyoshi TANAAMI, Saitama (JP); Masahiro HOKAZONO, Saitama (JP); Terumi FURUTA, Saitama (JP)

(21) Appl. No.: 19/632,425

(22) Filed: Mar. 30, 2026

(30) Foreign Application Priority Data
Mar. 31, 2025 (JP) 2025-058616

(51) Int. Cl. H01M 10/0585

(52) U.S. Cl. CPC H01M 10/0585

(57) ABSTRACT

Provided are an all-solid-state battery that can more suitably suppress local deposition of lithium and a method of manufacturing the same. In an all-solid-state battery, in a ZY cross section, a dimension in a Y direction of a positive electrode active material layer increases toward a positive electrode current collector side. A solid electrolyte layer covers an end portion of the positive electrode active material layer outside in the Y direction. A surface of the positive electrode active material layer has a first inclined portion. A surface of the solid electrolyte layer has a second inclined portion. An end portion of the second inclined portion closer to a negative electrode layer side is positioned more proximal to the outside in the Y direction than an end portion closer to the negative electrode layer side, of the first inclined portion.

### CROSS-REFERENCE TO RELATED APPLICATION

This application is based on and claims the benefit of priority from Japanese Patent Application No. 2025-058616, filed on 31 Mar. 2025, the content of which is incorporated herein by reference.

### BACKGROUND OF THE INVENTION

### Field of the Invention

The present invention relates to an all-solid-state battery and a method of manufacturing the all-solid-state battery.

### Related Art

In recent years, research and development of secondary batteries that contribute to energy efficiency has been carried out in order to ensure many people have access to reasonable, reliable, sustainable, and advanced energy.

Among the secondary batteries, all-solid-state batteries including a solid electrolyte are particularly receiving attention because they have an excellent feature of providing high safety due to the non-flammable nature of the solid electrolyte and having higher energy density. Studies are being conducted on an all-solid-state battery that has a laminated structure in which a plurality of electrodes (positive electrode layers and negative electrode layers) are alternately laminated with solid electrolyte layers interposed therebetween (for example, Japanese Unexamined Patent Application, Publication No. 2024-145930).

The all-solid-state battery of Japanese Unexamined Patent Application, Publication No. 2024-145930 includes an all-solid-state battery positive electrode with a positive electrode active material layer formed on a positive electrode current collector, an all-solid-state battery negative electrode with a negative electrode active material layer formed on a negative electrode current collector, a solid electrolyte layer that is disposed between the all-solid-state battery positive electrode and the all-solid-state battery negative electrode, and an insulating member that is provided on an outer periphery of the positive electrode active material layer. The positive electrode active material layer has an inclined portion that is inclined to widen in a direction away from the positive electrode current collector. The negative electrode active material layer contains metallic lithium or a lithium alloy.

According to the all-solid-state battery of Japanese Unexamined Patent Application, Publication No. 2024-145930, in the positive electrode of the all-solid-state battery, it is possible to suppress a current from concentrating on a boundary between the positive electrode active material layer and the insulating member, and suppress lithium from locally depositing on the negative electrode containing metallic lithium or a lithium alloy.

During manufacture of the all-solid-state battery of Japanese Unexamined Patent Application, Publication No. 2024-145930, the insulating member is disposed on the current collecting foil that is to be the positive electrode current collector, and thereafter, the positive electrode active material layer is disposed so as to overlap with the insulating member.

Patent Document 1: Japanese Unexamined Patent Application, Publication No. 2024-145930

### SUMMARY OF THE INVENTION

However, when the insulating member is disposed before the positive electrode active material layer, it becomes difficult to dispose the positive electrode active material layer. Consequently, the manufacturing method of the aforementioned all-solid-state battery leaves room for improvement in terms of positional accuracy of the positive electrode active material layer. Furthermore, if the positive electrode active material layer is not disposed at an appropriate position, concentration of current occurs, and there arises a risk that local deposition of lithium may occur.

In order to solve the above-described problem, an object of the present application is to provide an all-solid-state battery that can more suitably suppress local deposition of lithium, and a manufacturing method of the same. The present application will ultimately contribute to improvement in energy efficiency.

(1) The present invention relates to an all-solid-state battery including: a positive electrode layer including a positive electrode current collector and a positive electrode active material layer; a negative electrode layer including at least a negative electrode current collector; and a solid electrolyte layer disposed between the positive electrode layer and the negative electrode layer. A direction in which the positive electrode layer and the negative electrode layer are laminated via the solid electrolyte layer is defined as a lamination direction, a direction among directions orthogonal to the lamination direction is defined as a first direction, a direction orthogonal to the lamination direction and the first direction is defined as a second direction, a side in the second direction away from a central portion in the second direction of the all-solid-state battery is defined as an outside in the second direction, and the positive electrode current collector has a tab portion that extends in the first direction. In a cross section orthogonal to the lamination direction and the second direction, a dimension in the second direction of the positive electrode active material layer increases toward a positive electrode current collector side, the solid electrolyte layer covers an end portion of the positive electrode active material layer closer to the outside in the second direction, the positive electrode active material layer has a surface that is in contact with the solid electrolyte layer, and the surface has a first inclined portion that is inclined toward the outside in the second direction as approaching the positive electrode current collector side, the solid electrolyte layer has a surface that is in contact with the positive electrode active material layer and a surface that is opposite to said surface and has a second inclined portion that is inclined toward the outside in the second direction as approaching the positive electrode current collector side, and an end portion of the second inclined portion closer to a negative electrode layer side is positioned more proximal to the outside in the second direction than an end portion of the first inclined portion closer to the negative electrode layer side.

According to the all-solid-battery described in (1), it is possible to dispose the solid electrolyte layer and the negative electrode layer outside the region that overlaps with the positive electrode active material layer in the lamination direction. Lithium ions that are released from the first inclined portion moves in a straight line and reaches a part of the negative electrode layer that is not aligned with the positive electrode active material layer in the lamination direction, via the solid electrolyte layer. Accordingly, it is possible to suppress lithium from locally depositing on the end portion of the region that overlaps with the positive electrode active material layer in the lamination direction in the negative electrode layer 20.

Furthermore, according to the above configuration, it is possible to dispose the positive electrode active material layer on the positive electrode current collector before the solid electrolyte layer in the manufacture of the all-solid-state battery. Accordingly, it is possible to easily ensure the positional accuracy of the positive electrode active material layer, and therefore, it is possible to suppress local deposition of lithium caused by misalignment of the positive electrode active material layer.

Accordingly, it is possible to provide the all-solid-state battery that can more suitably suppress local deposition of lithium.

(2) The all-solid-state battery according to (1) above may further include an insulating member that is disposed around the positive electrode active material layer is included, and in the cross section orthogonal to the lamination direction and the second direction, the insulating member may cover the second inclined portion.

According to the all-solid-state battery described in (2), since the insulating member blocks a moving path of the lithium ions, it is possible to block, by the insulating member, a path through which the lithium ions released from the first inclined portion advance to a vicinity of the end portion of the negative electrode layer closer to the outside in the second direction. Accordingly, it is possible to suppress lithium from concentrating and depositing in a vicinity of a terminal end of the negative electrode layer.

(3) In the all-solid-state battery according to (1) or (2) above, the end portion of the second inclined portion closer to the negative electrode layer side may be positioned more proximal to the outside in the second direction than an end portion of the first inclined portion closer to the positive electrode current collector side.

According to the all-solid-state battery described in (3), when the lithium ions released from the first inclined portion move along the lamination direction, the lithium ions can be suppressed from hitting the edge of the solid electrolyte layer (or the insulating member). Accordingly, flow of lithium ions between the positive electrode active material layer and the negative electrode layer can be made smoother.

(4) In the all-solid-state battery according to (2) or (3) above, in the cross section orthogonal to the lamination direction and the second direction, when a region between the positive electrode current collector and the negative electrode layer that are adjacent to each other is divided into two equal regions in the lamination direction, one region of the two equal regions includes a region in which the insulating member and the solid electrolyte layer overlap with each other in the lamination direction, a region in which the solid electrolyte layer does not overlap with the positive electrode active material layer nor the insulating member in the lamination direction, and a region in which the positive electrode active material layer and the solid electrolyte layer overlap with each other in the lamination direction.

According to the all-solid-state battery described in (4) above, since the region is provided in which the positive electrode active material layer and the solid electrolyte layer overlap with each other in the lamination direction, it is possible to make it easier for lithium to deposit on the negative electrode layer. Furthermore, since the region is provided in which the solid electrolyte layer does not overlap with the positive electrode active material layer nor the insulating member in the lamination direction, lithium also can be deposited to some extent outside the end portion in the second direction of the portion that overlaps with the positive electrode active material layer in the lamination direction, of the negative electrode layer. Accordingly, it is possible to suppress lithium from locally depositing on the end portion in the second direction of the portion that overlaps with the positive electrode active material layer in the lamination direction, of the negative electrode layer. Furthermore, since the region is provided in which the insulating member and the solid electrolyte layer overlap with each other in the lamination direction, it is possible to suppress lithium from locally depositing on the end portion in the second direction of the negative electrode layer.

Furthermore, since the solid electrolyte layer is disposed so as to cover the end portion of the positive electrode active material layer, it is possible to reduce the likelihood that a gap is formed between the end portion of the positive electrode active material layer and the solid electrolyte layer during manufacture of the all-solid-state battery.

Furthermore, even if a gap is formed in the end portion closer to the negative electrode layer side in the boundary portion between the solid electrolyte layer and the insulating member when the insulating member is coated, the gap is formed at a position where it does not overlap with the positive electrode active material layer in the lamination direction. Accordingly, it is possible to suppress cracks caused by uneven reactions during charging.

(5) In the all-solid-state battery according to any one of (1) to (4) above, in the cross section orthogonal to the lamination direction and the second direction, a ratio of a length in the second direction between the end portion of the second inclined portion closer to the negative electrode layer side and an end portion of the first inclined portion closer to the positive electrode active material layer side to a dimension in the second direction of the first inclined portion may be 0.01 or more and 5000 or less.

According to the above configuration, by making the size of the solid electrolyte layer a certain size or more, it is possible to suitably ensure the path through which lithium ions reach the negative electrode layer from the first inclined portion via the solid electrolyte layer. Furthermore, by making the size of the solid electrolyte layer a certain size or less, it is possible to reduce the likelihood of formation of the solid electrolyte layer that does not contribute to conduction of lithium ions.

(6) In the all-solid-state battery according to any one of (2) to (5) above, in the cross section orthogonal to the lamination direction and the second direction, a ratio of a length in the second direction between the end portion of the second inclined portion closer to the negative electrode layer side and an end portion of the first inclined portion closer to the positive electrode active material layer side to a dimension in the second direction of the second inclined portion may be 0.01 or more and 5000 or less.

According to the all-solid-state battery described in (6), it is possible to suitably suppress occurrence of a short circuit, by disposing the insulating member of a certain size or more. Furthermore, by making the size of the insulating member a certain size or less, it is possible to suitably ensure the path through which lithium ions reach the negative electrode layer via the solid electrolyte layer from the first inclined portion.

(7) In the all-solid-state battery according to any one of (1) to (6) above, in the cross section orthogonal to the lamination direction and the second direction, the negative electrode layer may have, in a portion thereof overlapping with the second inclined portion in the lamination direction, a negative electrode inclined portion that is inclined toward the positive electrode current collector side as approaching the outside in the second direction.

According to the all-solid-state battery described in (7), it is possible to align the insulating member with the portion that is a part of the solid electrolyte layer and is positioned more proximal to the negative electrode layer than the end portion of the positive electrode active material layer closer to the negative electrode layer in the second direction. Accordingly, by pressing the lamination body including the positive electrode layer having the insulating member and the solid electrolyte layer, it is possible to increase density of the portion that is a part of the solid electrolyte layer and is positioned more proximal to the negative electrode layer than the end portion of the positive electrode active material layer closer to the negative electrode layer in the second direction.

(8) A manufacturing method of an all-solid-state battery of the present invention is a method of manufacturing the all-solid-state battery according to any one of (1) to (7) above, and the method includes: forming the positive electrode active material layer on the positive electrode current collector; and forming the solid electrolyte layer so that the solid electrolyte layer extends from a top of the positive electrode active material layer to a top of the positive electrode current collector.

According to the method of manufacturing the all-solid-state battery described in (8), it is possible to form the first inclined portion on the positive electrode active material layer and cover the first inclined portion with the solid electrolyte layer. Furthermore, when forming the positive electrode active material layer on the positive electrode current collector, it is possible to reduce the likelihood that work for forming the positive electrode current collector is restricted by the other members. Accordingly, it is possible to improve the positional accuracy of the positive electrode current collector. Furthermore, it is possible to improve workability when forming the positive electrode active material layer.

(9) A manufacturing method of an all-solid-state battery of the present invention is a method of manufacturing the all-solid-state battery according to any one of (2) to (8) above, and the method includes: forming the positive electrode active material layer on the positive electrode current collector; forming the solid electrolyte layer so that the solid electrolyte layer extends from a top of the positive electrode active material layer to a top of the positive electrode current collector; and forming the insulating member so that the insulating member extends from the top of the positive electrode current collector to a top of the solid electrolyte layer.

According to the manufacturing method of the all-solid-state battery described in (9), it is possible to form the second inclined portion in the solid electrolyte layer and cover the second inclined portion with the insulating member. Furthermore, since the positive electrode active material layer is formed before the insulating member, it is possible to form the positive electrode active material layer on the positive electrode current collector without being hindered by the insulating member. Accordingly, it is possible to improve the positional accuracy of the positive electrode current collector. Furthermore, it is possible to improve workability when forming the positive electrode active material layer.

According to the present invention, it is possible to provide the all-solid-state battery that can more suitably suppress local deposition of lithium and the manufacturing method thereof.

### BRIEF DESCRIPTION OF THE DRAWINGS

FIG. 1 is a plan view of an all-solid-state battery according to an embodiment seen in a lamination direction;

FIG. 2 is a side view of the all-solid-state battery according to the embodiment seen in a second direction;

FIG. 3 is a cross-sectional view of the all-solid-state battery along line III-III in FIG. 1; and

FIG. 4 is a view showing an all-solid-state battery according to a modification, which is a view corresponding to FIG. 3.

### DETAILED DESCRIPTION OF THE INVENTION

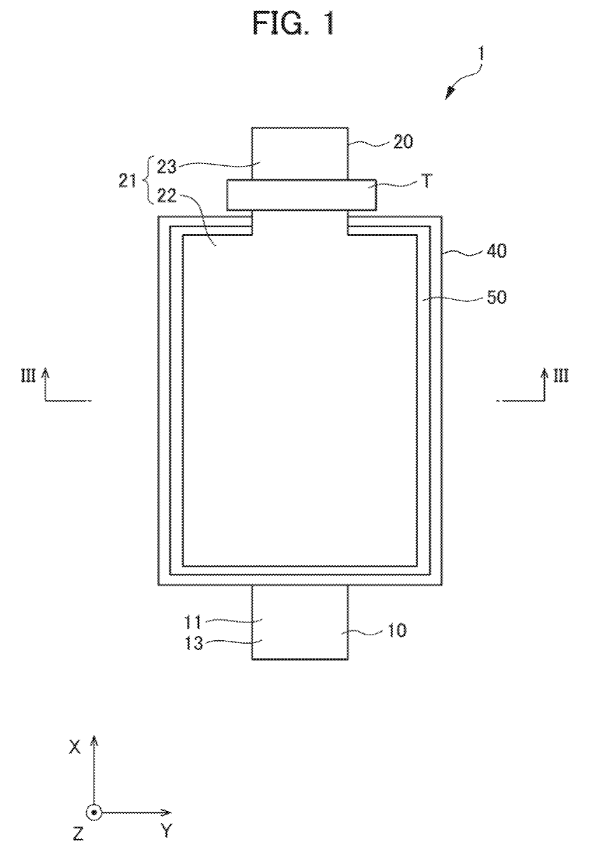

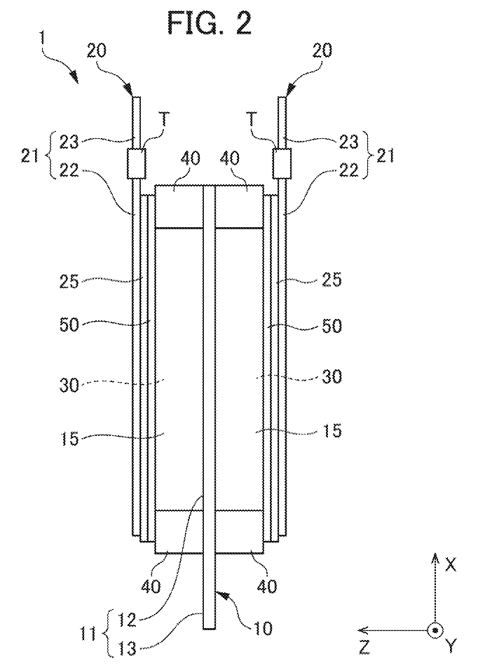

Hereinafter, an all-solid-state battery 1 of an embodiment of the present invention will be described. A type of the all-solid-state battery 1 is not particularly limited, but an example thereof includes an all-solid-state lithium battery using a lithium ion as a charge transfer medium. As shown in FIGS. 1 to 3, the all-solid-state battery 1 has a structure in which a positive electrode layer 10, and a negative electrode layer 20 are laminated via a solid electrolyte layer 30.

In the present specification, a direction in which the positive electrode layer 10 and the negative electrode layer 20 are laminated via the solid electrolyte layer 30 is defined as a "Z direction". The Z direction corresponds to the lamination direction. Of directions orthogonal to the Z direction, a direction in which an extended portion described later is extended is defined as an "X direction". The X direction corresponds to a first direction. A direction that is orthogonal to the Z direction and the X direction is defined as a "Y direction". The Y direction corresponds to a second direction. One side in the Z direction is defined as a "Z+ direction", and an opposite side to the Z+ direction is defined as a "Z- direction". One side of the X direction is defined as an "X+ direction", and an opposite side to the X+ direction is defined as an "X- direction". One side of the Y direction is defined as a "Y+ direction", and an opposite side to the Y+ direction is defined as a "Y- direction". A side in the Y direction away from a central portion in the Y direction of the all-solid-state battery 1 is defined as "the outside in the Y direction". The outside in the Y direction corresponds to an outside in the second direction. Note that the outside in the Y direction is indicated as "Yo" in the drawings.

A "negative electrode side" means a direction approaching one that exists closest of at least one negative electrode layer 20 seen from a spot that is an object to be explained. A "positive electrode current collector side" means a direction approaching one that exists closest of at least one positive electrode current collector 11 seen from a spot that is an object to be explained.

Note that the drawings may be drawn by being schematically simplified to explain the contents of the invention, and ratios of the dimensions of the depicted components or between the components may not match ratios of dimensions thereof described in the specification. Furthermore, components described in the specification may be omitted in the drawings, or may be drawn but the numbers of them may be omitted. Note that terms to specify shapes and geometric conditions, as well as degrees thereof, such as "straight line", "parallel", "orthogonal", "identical", and "flush", values of lengths and angles, and the like that are used in the present invention are not to be bound by strict meanings, but are to be interpreted to include the range of degrees to which similar functions can be expected.

### All-Solid-State Battery

The all-solid-state battery 1 includes, for example, the positive electrode layer 10 including a positive electrode current collector 11 and a positive electrode active material layer 15, the negative electrode layer 20 including at least a negative electrode current collector 21, and the solid electrolyte layer 30 disposed between the positive electrode layer 10 and the negative electrode layer 20, and in more detail, includes the one positive electrode layer 10, two negative electrode layers 20, and two solid electrolyte layer 30. However, the number of laminated positive electrode layer 10, the number of laminated negative electrode layers 20, and the number of laminated solid electrolyte layers 30 are not particularly limited.

### Positive Electrode Layer

The one positive electrode layer 10 has, for example, the one positive electrode current collector 11, and two positive electrode active material layers 15 that are provided to sandwich the positive electrode current collector 11 in the Z direction.

The positive electrode current collector 11 is provided adjacently to the positive electrode active material layers 15. The positive electrode current collector 11 is formed of a current collector. Examples of the current collector include aluminum, copper, nickel, vanadium, iron, titanium, stainless steel, gold, white gold, carbon, and the like. The positive electrode current collector 11 is formed of, for example, aluminum. Examples of a shape of the positive electrode current collector 11 include a foil shape, a plate shape, a mesh shape, a nonwoven fabric shape, a foam shape, and the like. The positive electrode current collector 11 has a positive electrode portion 12, and a positive electrode tab portion 13.

The positive electrode portion 12 overlaps with the adjacent positive electrode active material layers 15 in the Z direction. A shape of the positive electrode portion 12 seen in the Z direction is, for example, a rectangular shape in which long sides extend in the X direction.

The positive electrode tab portion 13 extends in the X direction, specifically, in the X+ direction, from the positive electrode portion 12. A dimension in the Y direction of the positive electrode tab portion 13 is smaller than a dimension in the Y direction of the positive electrode portion 12. A shape seen in the Z direction view of the positive electrode tab portion 13 is, for example, a substantially rectangular shape in which long sides extend along the X direction.

The positive electrode active material layer 15 includes a positive electrode active material. Examples of the positive electrode active material include transition metal chalcogenides such as titanium disulfide, molybdenum disulfide, and niobium selenide, transition metal oxides such as lithium nickel oxide (LiNiO₂), lithium manganese oxide (LiMnO₂, LiMn₂O₄), and lithium cobalt oxide (LiCoO₂), and the like. The positive electrode active material layer 15 may further contain a solid electrolyte, a conductive additive, a binder and the like. The positive electrode active material may be a ternary lithium nickel cobalt manganese composite oxide (NCM) material that is generally used in lithium ion batteries or a lithium nickel cobalt aluminum oxide (NCA) material.

A shape in Z direction view of the positive electrode active material layer 15 is, for example, a rectangular shape in which long sides extend along the X direction.

### Solid Electrolyte Layer

The solid electrolyte layer 30 is, for example, a single layer. Two or more solid electrolyte layers 30 may be provided by being laminated. The solid electrolyte layer 30 contains a solid electrolyte material. Examples of the solid electrolyte material include a sulfide solid electrolyte material, an oxide solid electrolyte material, and the like.

### Negative Electrode Layer

The one negative electrode layer 20 has, for example, one negative electrode current collector 21, and one negative electrode active material layer 25.

The negative electrode current collector 21 is provided adjacently to the negative electrode active material layer 25. The negative electrode current collector 21 is not particularly limited, but is made of, for example, copper. Examples of a shape of the negative electrode current collector 21 include a foil shape, a plate shape, a mesh shape, a nonwoven fabric shape, a foam shape, and the like. The negative electrode current collector 21 has a negative electrode portion 22, and a negative electrode tab portion 23.

The negative electrode portion 22 overlaps with the adjacent negative electrode active material layer 25 in the Z direction. A shape in a Z direction view of the negative electrode portion 22 is, for example, a substantially rectangular shape in which long sides extend along the X direction.

The negative electrode tab portion 23 extends in the X direction, specifically, extends in the X- direction, from the negative electrode portion 22. A dimension in the Y direction of the negative electrode tab portion 23 is smaller than a dimension in the Y direction of the negative electrode portion 22. A shape in the Z direction view of the negative electrode tab portion 23 is, for example, a substantially rectangular shape in which long sides extend along the X direction. For example, an insulating tape T is disposed at a base end portion of the negative electrode tab portion 23. Accordingly, it is possible to suppress occurrence of a short circuit caused by contact of the negative electrode tab portion 23 with other parts.

The negative electrode active material layer 25 contains a negative electrode active material. Examples of the negative electrode active material include lithium metal, lithium alloys, silicon active material such silicon (Si), and silicon alloys, a lithium transition metal oxide such as lithium titanate (Li₄Ti₅O₁₂), transition metal oxides such as TiO₂, Nb₂O₃, and WO₃, metal sulfides, metal nitrides, carbon materials such as graphite, soft carbon, and hard carbon, metal indium, and the like. The negative electrode active material layer 25 is preferably made of lithium metal. The negative electrode active material layer 25 may further contain a solid electrolyte, a conductive additive, a binder, and the like.

A shape of the negative electrode active material layer 25 is, for example, a plate shape in which a plate surface extends along the X direction and the Y direction. A shape in the Z direction view of the negative electrode active material layer 25 is, for example, a rectangular shape in which long sides extend along the X direction.

### Insulating Member

Furthermore, the all-solid-state battery 1 may include, for example, a plurality of insulating members 40 that are disposed around the positive electrode active material layer 15.

The insulating member 40 has non-electronic conductivity, and non-ionic conductivity. The insulating member 40 contains a material having insulating property. Examples of the material having insulating property include an insulating oxide such as alumina, resin such as polyvinylidene fluoride (PVDF), rubber such as styrene-butadiene rubber (SBR), and the like. The insulating member 40 is preferably formed of alumina. A shape in the Z direction view of the insulating member 40 is, for example, a rectangular frame shape.

### Intermediate Layer

Furthermore, the all-solid-state battery 1 may include, for example, a plurality of intermediate layers 50 provided between the negative electrode layer 20 and the solid electrolyte layer 30.

The intermediate layer 50 contains, for example, metal that can be alloyed with lithium, and carbon. Examples of the metal that can be alloyed with lithium include Mg, Zn, Al, In, Si, Ge, Sn, Ag, Au, Pt, Pd, Pb, Sb, Mn, and Bi. A shape of the intermediate layer 50 is, for example, a substantially rectangular plate shape in which a plate surface extends in the X direction and the Y direction.

The intermediate layer 50 is formed to be flexible as compared with the negative electrode layer 20 and the solid electrolyte layer 30. Consequently, the intermediate layer 50 is suitably in tight contact with each of the negative electrode layer 20 and the solid electrolyte layer 30. According to the intermediate layer 50, it is possible to suppress delamination between the negative electrode layer 20 and the solid electrolyte layer 30.

### Configuration of Positive Electrode Active Material Layer And Surroundings Thereof

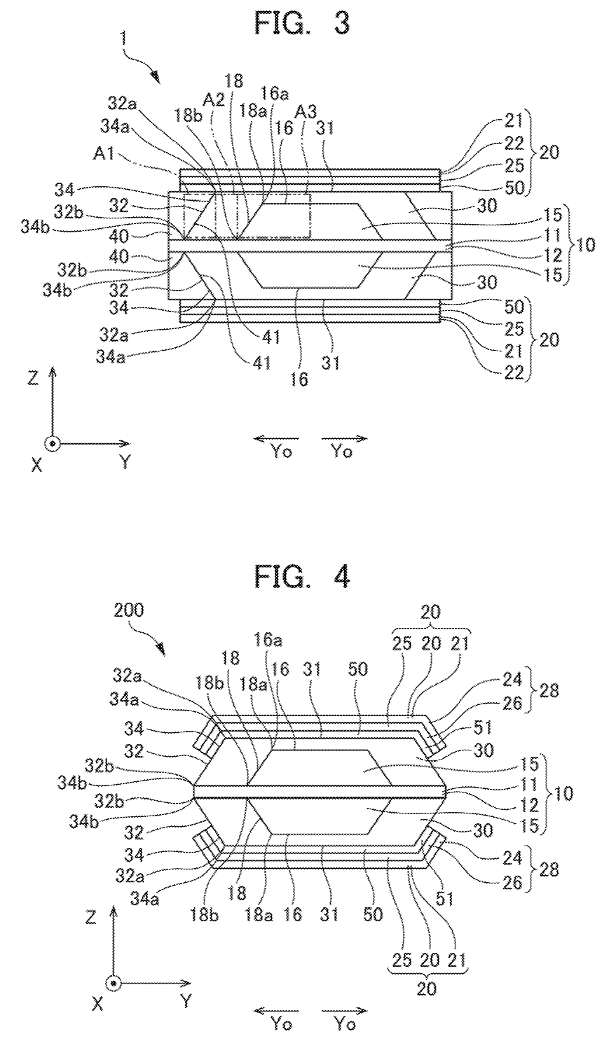

Here, a configuration of the positive electrode active material layer and surroundings thereof in a cross section (may be referred to as a "ZY cross section") orthogonal to the Z direction and the Y direction will be described with reference to FIG. 3. Note that FIG. 3 is a ZY cross section that passes through a central portion in the Y direction of the all-solid-state battery 1.

As shown in FIG. 3, in the ZY cross section, a dimension in the Y direction of the positive electrode active material layer 15 increases toward a positive electrode current collector 11 side. The solid electrolyte layer 30 covers an end portion closer to the outside in the Y direction of the positive electrode active material layer 15. The positive electrode active material layer 15 has a surface 16 that is in contact with the solid electrolyte layer 30, and the surface 16 has a first inclined portion 18 that is inclined toward the outside in the Y direction as approaching the positive electrode current collector 11 side. The solid electrolyte layer 30 has a surface that is in contact with the positive electrode active material layer 15 and a surface 31 that is opposite to the surface and has a second inclined portion 32 that is inclined toward the outside in the Y direction as approaching the positive electrode current collector 11 side. An end portion 32a of the second inclined portion 32 closer to a negative electrode layer 20 side is positioned more proximal to the outside in the Y direction than an end portion 18a of the first inclined portion 18 closer to the negative electrode layer 20 side.

The positive electrode active material layer 15 has a substantially trapezoidal shape that tapers toward the negative electrode layer 20 side, for example. The end portion 18a of the first inclined portion 18 closer to the negative electrode layer 20 side is in contact with the solid electrolyte layer 30, and an end portion 18b of the first inclined portion 18 closer to the positive electrode current collector 11 side is in contact with the positive electrode current collector 11.

The solid electrolyte layer 30 covers the first inclined portion 18, and specifically, covers the entirety of the first inclined portion 18. The solid electrolyte layer 30 covers the entirety of the positive electrode active material layer 15. The solid electrolyte layer 30 extends from a top of the solid electrolyte layer 30 to a top of the positive electrode current collector 11. The solid electrolyte layer 30 is in contact with the positive electrode active material layer 15, and the positive electrode current collector 11. The positive electrode active material layer 15, and the solid electrolyte layer 30 are respectively in contact with the positive electrode current collector 11. The solid electrolyte layer 30 is in contact with the positive electrode active material layer 15 in the Y direction. The end portion 32a of the second inclined portion 32 closer to the negative electrode layer 20 side is in contact with the intermediate layer 50, and an end portion 32b of the second inclined portion 32 closer to the positive electrode current collector 11 side is in contact with the positive electrode current collector 11.

The insulating member 40 preferably covers the second inclined portion 32.

The end portion 32a closer to the negative electrode layer 20 side, of a portion that is in contact with the insulating member 40, in the second inclined portion 32 is preferably positioned more proximal to the outside in the Y direction than The end portion 18a of the first inclined portion 18 closer to the negative electrode layer 20 side. The insulating member 40 covers, for example, the entirety of the second inclined portion 32. In the insulating member 40, a surface that is in contact with the second inclined portion 32 has a third inclined portion 41 that is inclined toward the outside in the Y direction as approaching the positive electrode current collector 11 side. In the second inclined portion 32, an end portion 34a closer to the negative electrode layer 20 side, of a portion 34 that is in contact with the insulating member 40 coincides with the end portion 32a closer to the negative electrode layer 20 side, of the second inclined portion 32, for example. In the second inclined portion 32, an end portion 34b closer to the positive electrode current collector 11 side, of the portion 34 that is in contact with the insulating member 40 coincides with the end portion 32b closer to the positive electrode current collector 11 side, of the second inclined portion 32, for example. A surface closer to the negative electrode layer 20 side, of the insulating member 40 is flush with a portion where the second inclined portion 32 is not provided, of the surface closer to the negative electrode layer 20 side, of the solid electrolyte layer 30. Accordingly, it is possible to make stress that acts on an interface between the solid electrolyte layer 30 and the positive electrode active material layer 15 more uniform during use of the all-solid-state battery 1. Accordingly, it is possible to suppress occurrence of local reaction in the interface between the solid electrolyte layer 30 and the positive electrode active material layer 15.

The end portion 32a of the second inclined portion 32 closer to the negative electrode layer 20 side is preferably positioned more proximal to the outside in the Y direction than the end portion 18b of the first inclined portion 18 closer to the positive electrode current collector 11 side.

In the ZY cross section, when a region between the positive electrode current collector 11 and the negative electrode layer 20 that are adjacent to each other is divided into two equal regions in the X direction, one region of the two equal regions includes a region A1 (may be simply referred to as a "region A1") in which the insulating member 40 and the solid electrolyte layer 30 overlap with each other in the Z direction, a region A2 (may be simply referred to as a "region A2") in which the solid electrolyte layer 30 does not overlap with the positive electrode active material layer 15 nor the insulating member 40 in the Z direction, and a region A3 (may be simply referred to as a "region A3") in which the positive electrode active material layer 15 and the solid electrolyte layer 30 overlap with each other in the Z direction are formed. Note that in the region A1, the solid electrolyte layer 30 does not overlap with the positive electrode active material layer 15 in the Z direction. In the region A3, the solid electrolyte layer 30 does not overlap with the insulating member 40 in the Z direction.

In the ZY cross section, a ratio of an area, of a portion of the solid electrolyte layer 30, that overlaps with the positive electrode current collector 11 in the Y direction to an area of the positive electrode active material layer 15 is preferably 0.01 or more and 5000 or less.

In the ZY cross section, a ratio of an area of a portion, of the insulating member 40, that overlaps with the positive electrode current collector 11 in the Y direction to the area of the positive electrode active material layer 15 is preferably 0.01 or more and 5000 or less.

A position in the Z direction of the end portion of the first inclined portion 18 closer to the negative electrode layer 20 side is preferably the same as a position in the Z direction of the end portion 32a of the second inclined portion 32 closer to the negative electrode layer 20 side, or more proximal to the positive electrode current collector 11 than the position in the Z direction of the end portion 32a of the second inclined portion 32 closer to the negative electrode layer 20 side.

A position in the Z direction of an end portion 16a closer to the negative electrode layer 20 side of the surface 16 that is contact with the solid electrolyte layer 30, of the positive electrode active material layer 15 is preferably the same as a position in the Z direction of the end portion 34a closer to the negative electrode layer 20 side, of the portion 34 that is in contact with the insulating member 40, of the solid electrolyte layer 30, or more proximal to the positive electrode current collector 11 than the position in the Z direction of the end portion 34a closer to the negative electrode layer 20 side, of the portion 34 that is in contact with the insulating member 40, of the solid electrolyte layer 30.

An end portion of the negative electrode active material layer 25 closer to the outside in the Y direction is positioned more proximal to the outside in the Y direction than an end portion of the positive electrode active material layer 15 closer to the outside in the Y direction, for example. The end portion of the insulating member 40 closer to the outside in the Y direction is positioned more proximal to the outside in the Y direction than the end portion of the negative electrode active material layer 25 closer to the outside in the Y direction, for example.

Furthermore, in the Z direction view, an area of the negative electrode layer 20 is preferably larger than an area of the positive electrode active material layer 15. According to the above configuration, in the negative electrode layer 20, an area of a portion that is not aligned with the positive electrode active material layer 15 in the Z direction can be enlarged, and therefore it is possible to easily enlarge an area of a region where lithium can be deposited, in the negative electrode layer 20.

Furthermore, in the Z direction view, the entirety of a portion (in other words, the negative electrode portion 22) except for the negative electrode tab portion 23, of the negative electrode current collector 21 is preferably disposed inside of a contour line of an outside of the insulating member 40. According to the above configuration, it is possible to easily protect deposited lithium by the insulating member 40 when lithium deposits in a vicinity of the end portion in a direction orthogonal to the Z direction, of the negative electrode layer 20. Accordingly, it is possible to suppress detachment of lithium, and therefore, it is possible to improve cycle characteristics.

### Manufacturing Method of ALL-Solid-State Battery

Subsequently, a manufacturing method of the all-solid-state battery 1 according to the present embodiment will be described.

The manufacturing method of the all-solid-state battery according to the present embodiment includes, for example, a positive electrode active material layer forming process, a solid electrolyte layer forming process, an insulating member forming process, a positive electrode side pressing process, a positive electrode side cutting process, a negative electrode active material layer forming process, an intermediate layer forming process, a negative electrode side cutting process, a negative electrode side pressing process, a laminating process, and an integrated pressing process.

### Positive Electrode Active Material Layer Forming Process

The positive electrode active material layer 15 is formed on the positive electrode current collector 11. More specifically, aluminum foil to be the positive electrode current collector 11 is prepared. The aluminum foil is, for example, in a long shape. A slurry for a positive electrode active material layer to be the positive electrode active material layer 15 is applied onto the aluminum foil by using, for example, an intermittent coating device, and dried. The slurry for a positive electrode active material layer is applied a plurality of times at intervals in the Y direction, for example. Accordingly, a positive electrode connected body is obtained, in which a plurality of positive electrode active material layers 15 are laminated on a connected body of the positive electrode current collectors 11. Furthermore, when applying the slurry for a positive electrode active material layer, it is possible to form the first inclined portion 18 in each of the end portions in the Y direction of the positive electrode active material layers 15 by properly adjusting viscosity of the slurry for a positive electrode active material layer, and a coating speed.

### Solid Electrolyte Layer Forming Process

Next, the solid electrolyte layer 30 is formed to extend from the top of the positive electrode active material layer 15 to the top of the positive electrode current collector 11. More specifically, a slurry for a solid electrolyte layer to be the solid electrolyte layer 30 is applied onto the positive electrode connected body by using, for example, an intermittent coating device, and is dried. At this time, the slurry for a solid electrolyte layer is applied so as to extend from the top of the positive electrode active material layer 15 to the top of the positive electrode current collector 11. The slurry for a solid electrolyte layer is applied to each of the end portions in the Y direction of the solid electrolyte layer 30 so as to form the second inclined portion 32. Accordingly, the positive electrode connected body on which the solid electrolyte layer 30 is laminated is obtained. The solid electrolyte layer 30 is in contact with the positive electrode active material layers 15 in the Y direction, and covers the first inclined portions 18. Furthermore, when applying the slurry for a solid electrolyte layer, it is possible to form the second inclined portion 32 in each of the end portions in the Y direction of the solid electrolyte layer 30 by properly adjusting viscosity of the slurry for a solid electrolyte layer, and a coating speed.

### Insulating Member Forming Process

Next, the insulating member 40 is formed so as to extend from the top of the positive electrode current collector 11 to the top of the solid electrolyte layer 30. More specifically, an insulating material to be the insulating member 40 is applied onto the positive electrode current collector 11 by using, for example, an intermittent coating device, and is cured. At this time, the insulating material is applied so as to surround a region around the solid electrolyte layer 30. The insulating material is applied so that a part of the insulating material overlaps with a peripheral edge portion of the solid electrolyte layer. Accordingly, the positive electrode connected body on which the solid electrolyte layer 30 is laminated with the insulating member 40 attached is obtained. The insulating member 40 is in contact with the solid electrolyte layer 30 in the Y direction, and covers the second inclined portion 32. Furthermore, the third inclined portion 41 is formed on a portion that overlaps with the second inclined portion 32 of the solid electrolyte layer 30, of the insulating member 40. Note that the insulating member 40 may be applied by using, for example, a spray.

### Positive Electrode Side Pressing Process

Next, the positive electrode connected body on which the solid electrolyte layer 30 is laminated with the insulating member 40 attached is pressed by, for example, a roll press device. At this time, a temperature is, for example, a room temperature or 25° C. to 100° C., and pressure is, for example, 500 MPa to 1200 MPa. Accordingly, the positive electrode active material layer 15, the solid electrolyte layer 30, and the insulating member 40 are integrated, and the solid electrolyte layer 30 can be densified. Furthermore, the first inclined portion 18, the second inclined portion 32, and the third inclined portion 41 can be respectively enlarged, or made more linear.

The positive electrode active material layer 15 is easier to roll than the solid electrolyte layer 30. Since the solid electrolyte layer 30, and the positive electrode active material layer 15 are in contact with each other in the Y direction, the solid electrolyte layer 30 is suitably rolled following the positive electrode active material layer 15. Furthermore, a gap between the positive electrode active material layer 15 and the insulating member 40 is suitably filled with the solid electrolyte layer 30.

Furthermore, since the surface of the insulating member 40 closer to the negative electrode layer 20 side, and the surface of the portion where the second inclined portion 32 is not formed, of the surface closer to the negative electrode layer 20 side, of the solid electrolyte layer 30 are flush with each other, pressure can more easily act onto the solid electrolyte layer 30 uniformly during pressing described later, as compared with the case in which the insulating member 40 is disposed on the positive electrode active material layer 15 and the solid electrolyte layer 30 that are disposed by being aligned in the Y direction. Accordingly, it is possible to prevent cracks in the solid electrolyte layer 30 during pressing.

### Positive Electrode Side Cutting Process

Next, the positive electrode connected body on which the solid electrolyte layer 30 is laminated with the insulating member 40 attached is cut along the Y direction by using, for example, a rotary cutter. A portion to be the positive electrode tab portion 13 in the positive electrode current collector 11 is cut into a desired shape. Accordingly, a lamination body of the solid electrolyte layer 30 and the positive electrode layer 10 with the insulating member 40 attached is obtained.

### Negative Electrode Active Material Layer Forming Process

Furthermore, a slurry for a negative electrode active material layer to be the negative electrode active material layer 25 is applied onto copper foil to be the negative electrode current collector 21 by using, for example, an intermittent coating device. The copper foil is, for example, in a long shape. Accordingly, a negative electrode connected body is obtained in which a plurality of negative electrode active material layers 25 are laminated on the copper foil to be the negative electrode current collector 21.

### Intermediate Layer Forming Process

Next, the intermediate layer 50 is formed on the negative electrode connected body. The intermediate layer 50 is transferred onto the negative electrode active material layers 25 by using, for example, an intermediate layer transfer sheet. Accordingly, the negative electrode connected body on which the intermediate layer 50 is laminated is obtained. Note that the intermediate layer transfer sheet is obtained by applying a slurry that is obtained by dispersing materials that make up the intermediate layer 50 in a solvent onto a support sheet, and drying it.

### Negative Electrode Side Pressing Process

Next, the negative electrode connected body on which the intermediate layer 50 is laminated is pressed by, for example, a roll pressing device. At this time, a temperature is, for example, a room temperature or 25° C. to 100° C., and pressure is, for example, 500 MPa to 1200 MPa. Accordingly, the negative electrode current collector 21, the negative electrode active material layer 25, and the intermediate layer 50 are integrated.

### Negative Electrode Side Cutting Process

Next, the negative electrode connected body on which the intermediate layer 50 is laminated is cut along the second direction by using, for example, a rotary cutter. A portion to become the negative electrode tab portion 13, of the negative electrode current collector 21 is cut into a desired shape. Accordingly, a lamination body of the intermediate layer 50 and the negative electrode layer 20 is obtained. Note that the insulating tape T may be pasted on a base end portion of the negative electrode tab portion 23.

### Laminating Process

Next, the lamination body of the solid electrolyte layer 30 and the positive electrode layer 10 with the insulating member 40 attached, and the lamination body of the intermediate layer 50 and the negative electrode layer 20 are laminated. At this time, laminating of the intermediate layer 50 and the negative electrode layer 20 is performed on both surfaces of the lamination body of the solid electrolyte layer 30 and the positive electrode layer 10 with the insulating member 40 attached. Accordingly, the all-solid-state battery 1 has a structure in which the respective layers are symmetrically laminated on both the surfaces in the Z direction as shown in FIGS. 1 to 3.

### Integrated Pressing Process

Next, the lamination body of the solid electrolyte layer 30 and the positive electrode layer 10 with the insulating member 40 attached, and the lamination body of the intermediate layer 50 and the negative electrode layer 20 are pressed by, for example, a roll pressing device. At this time, a temperature is, for example, a room temperature or 25° C. to 100° C., and pressure is, for example, 200 MPa to 800 MPa. Accordingly, the positive electrode layer 10, the negative electrode layers 20, the solid electrolyte layers 30, and the intermediate layers 50 are integrated, and the solid electrolyte layers 30 are further densified. Furthermore, the first inclined portions 18, the second inclined portions 32, and the third inclined portions 41 can be respectively enlarged or made more linear.

Note that the positive electrode side pressing process, and the integrated pressing process respectively correspond to a process of laminating and pressing the positive electrode current collector, the positive electrode active material layer, and the solid electrolyte layer.

From the above, the all-solid-state battery 1 as shown in FIG. 1 is obtained.

Note that the manufacturing method of the all-solid-state battery 1 is not limited to the aforementioned manufacturing method. For example, the positive electrode layer 10 may not be necessarily obtained by cutting the positive electrode connected body, but may be obtained by laminating the one positive electrode active material layer 15 on the one positive electrode current collector 11. The same applies to the negative electrode layer 20.

### Effect According to Embodiment

According to the above-described embodiment, the following effects can be obtained.

In the all-solid-state battery 1 of the above-described embodiment, in the ZY cross section, the dimension in the Y direction of the positive electrode active material layer 15 increases toward the positive electrode current collector 11 side. The solid electrolyte layer 30 covers the end portion of the positive electrode active material layer 15 closer to the outside in the Y direction. The positive electrode active material layer 15 has the surface 16 that is in contact with the solid electrolyte layer 30, and the surface 16 has the first inclined portion 18 that is inclined toward the outside in the Y direction as approaching the positive electrode current collector 11 side. The solid electrolyte layer 30 has a surface that is in contact with the positive electrode active material layer 15 and the surface 31 that is opposite to the surface and has the second inclined portion 32 that is inclined toward the outside in the Y direction as approaching the positive electrode current collector 11 side. The end portion 32a of the second inclined portion 32 closer to the negative electrode layer 20 side is positioned more proximal to the outside in the Y direction than the end portion 18a of the first inclined portion 18 closer to the negative electrode layer 20 side.

According to the above configuration, it is possible to dispose the solid electrolyte layer 30 and the negative electrode layer 20 outside the region that overlaps with the positive electrode active material layer 15 in the Z direction. Lithium ions that are released from the first inclined portion 18 moves in a straight line and reaches a part of the negative electrode layer 20 that is not aligned with the positive electrode active material layer 15 in the Z direction, via the solid electrolyte layer 30. Accordingly, it is possible to suppress lithium from locally depositing on the end portion of the region that overlaps with the positive electrode active material layer 15 in the Z direction, of the negative electrode layer 20.

Furthermore, according to the above configuration, it is possible to dispose the positive electrode active material layer 15 on the positive electrode current collector 11 before the solid electrolyte layer 30 during manufacture of the all-solid-state battery 1. Accordingly, it is possible to easily ensure the positional accuracy of the positive electrode active material layer 15, and therefore, it is possible to suppress local deposition of lithium caused by misalignment of the positive electrode active material layer 15.

Accordingly, it is possible to provide the all-solid-state battery 1 that can more suitably suppress local deposition of lithium.

Furthermore, since the dimension in the Y direction of the positive electrode active material layer 15 increases toward the positive electrode current collector 11 side, it is possible to dispose the end portions of the positive electrode active material layer 15 closer to the negative electrode layer 20 side and the outside in the Y direction away from the end portions of the all-solid-state battery 1 in the Y direction, and therefore it is possible to suitably ensure insulation performance.

The all-solid-state battery 1 of the above-described embodiment preferably includes the insulating member 40, and the insulating member 40 preferably covers the second inclined portion 32.

According to the above configuration, since the insulating member 40 blocks a moving path of the lithium ions, it is possible to block, by the insulating member 40, a path through which the lithium ions released from the first inclined portion 18 advance to a vicinity of the end portion of the negative electrode layer 20 closer to the outside in the Y direction. Accordingly, it is possible to suppress lithium from concentrating and depositing in a vicinity of a terminal end of the negative electrode layer 20.

Furthermore, when the lamination body of the positive electrode layer 10 with the insulating member 40 attached, and the solid electrolyte layer 30 is pressed, the solid electrolyte layer 30 tends to extend in the Y direction following the rolling of the positive electrode active material layer 15. However, according to the above configuration, the rolling in the Y direction of the solid electrolyte layer 30 is suppressed by the insulating member 40. Accordingly, it is possible to compress the solid electrolyte layer 30, and therefore, it is possible to more highly densify the solid electrolyte layer 30 as compared with a configuration in which the insulating member 40 is not provided.

Furthermore, since the end portion closer to the negative electrode layer 20 side, of the portion that is in contact with the insulating member 40, of the second inclined portion 32 is positioned more proximal to the outside in the Y direction than the end portion of the first inclined portion 18 closer to the negative electrode layer 20 side, it is possible to suppress the insulating member 40 from being disposed on the path through which the lithium ions released from the first inclined portion 18 reach the negative electrode layer 20. Accordingly, it is also possible to suitably suppress local deposition of lithium in the all-solid-state battery 1 including the insulating member 40.

In the all-solid-state battery 1 of the above-described embodiment, the end portion 32a of the second inclined portion 32 closer to the negative electrode layer 20 side is preferably positioned more proximal to the outside in the Y direction than the end portion 18b of the first inclined portion 18 closer to the positive electrode current collector 11 side.

According to the above configuration, when the lithium ions released from the first inclined portion 18 move along the Z direction, the lithium ions can be suppressed from hitting the edge of the solid electrolyte layer 30 (or the insulating member 40). Accordingly, flow of the lithium ions between the positive electrode active material layer 15 and the negative electrode layer 20 can be made smoother.

In the all-solid-state battery 1 of the above-described embodiment, in the ZY cross section, when the region between the positive electrode current collector 11 and the negative electrode layer 20 that are adjacent to each other is divided into the two equal regions in the X direction, one region of the two equal regions includes the region A1 in which the insulating member 40 and the solid electrolyte layer 30 overlap with each other in the Z direction, the region A2 in which the solid electrolyte layer 30 does not overlap with the positive electrode active material layer 15 nor the insulating member 40 in the Z direction, and the region A3 in which the positive electrode active material layer 15 and the solid electrolyte layer 30 overlap with each other in the Z direction are formed.

According to the above configuration, since the region A3 is provided, it is possible to make it easier for lithium to deposit on the negative electrode layer 20. Furthermore, since the region A2 is provided, lithium also can be deposited to some extent outside the end portion in the Y direction of the portion that overlaps with the positive electrode active material layer 15 in the Z direction, of the negative electrode layer 20. Accordingly, it is possible to suppress lithium from locally depositing on the end portion in the Y direction of the portion that overlaps with the positive electrode active material layer 15 in the Z direction, of the negative electrode layer 20. Furthermore, since the region A1 is provided, it is possible to suppress lithium from locally depositing on the end portion in the Y direction of the negative electrode layer 20.

Furthermore, since the solid electrolyte layer 30 is disposed so as to cover the end portion of the positive electrode active material layer 15, it is possible to reduce the likelihood that a gap is formed between the portion of the positive electrode active material layer 15 and the solid electrolyte layer 30 in the manufacture of the all-solid-state battery 1.

Furthermore, even if a gap is formed in the end portion closer to the negative electrode layer 20 side in the boundary portion between the solid electrolyte layer 30 and the insulating member 40 when the insulating member 40 is coated, the gap is formed at a position where it does not overlap with the positive electrode active material layer 15 in the Z direction. Accordingly, it is possible to suppress cracks caused by uneven reactions during charging.

In the all-solid-state battery 1 of the above-described embodiment, in the ZY cross section, a ratio of a length between the end portion of the second inclined portion 32 closer to the negative electrode layer 20 side and the end portion of the first inclined portion 18 closer to the positive electrode active material layer 15 side to a dimension in the Y direction of the first inclined portion 18 is preferably 0.01 or more and 5000 or less.

According to the above configuration, by making the size of the solid electrolyte layer 30 a certain size or more, it is possible to suitably ensure the path through which lithium ions reach the negative electrode layer 20 from the first inclined portion 18 via the solid electrolyte layer 30. Furthermore, by making the size of the solid electrolyte layer 30 a certain size or less, it is possible to reduce the likelihood of formation of the solid electrolyte layer 30 that does not contribute to conduction of lithium ions.

In the all-solid-state battery 1 of the above-described embodiment, in the ZY cross section, a ratio of a length in the Y direction between the end portion of the second inclined portion 32 closer to the negative electrode layer 20 side and the end portion of the first inclined portion 18 closer to the positive electrode active material layer 15 side to the dimension in the Y direction of the second inclined portion 32 is preferably 0.01 or more and 5000 or less.

According to the above configuration, it is possible to suitably suppress occurrence of a short circuit, by disposing the insulating member 40 of a certain size or more. Furthermore, by making the size of the insulating member 40 a certain size or less, it is possible to suitably ensure the path through which lithium ions reach the negative electrode layer 20 via the solid electrolyte layer 30 from the first inclined portion 18.

In the all-solid-state battery 1 of the above-described embodiment, the position of the end portion 18a of the first inclined portion 18 closer to the negative electrode layer 20 side is preferably the same in the Z direction as the position of the end portion 32a of the second inclined portion 32 closer to the negative electrode layer 20 side, or more proximal in the Z direction of to the positive electrode current collector 11 side than the position the end portion 32a of the second inclined portion 32 closer to the negative electrode layer 20 side.

According to the above configuration, it is possible to align the insulating member 40 in the Y direction with the portion that is a part of the solid electrolyte layer 30 and is positioned more proximal to the negative electrode layer 20 side than the end portion of the positive electrode active material layer 15 closer to the negative electrode layer 20 side. Accordingly, by pressing the lamination body of the positive electrode layer 10 with the insulating member 40 attached and the solid electrolyte layer 30, it is possible to increase density of the portion that is a part of the solid electrolyte layer 30 and is positioned closer to the negative electrode layer 20 side than the end portion of the positive electrode active material layer 15 closer to the negative electrode layer 20 side.

The manufacturing method of the all-solid-state battery 1 of the above-described embodiment includes the process of forming the positive electrode active material layer 15 on the positive electrode current collector 11, and the process of forming the solid electrolyte layer 30 so that it extends from the top of the positive electrode active material layer 15 to the top of the positive electrode current collector 11.

According to the above manufacturing method, it is possible to form the first inclined portion 18 in the positive electrode active material layer 15 and cover the first inclined portion 18 with the solid electrolyte layer 30. Furthermore, when forming the positive electrode active material layer 15 on the positive electrode current collector 11, it is possible to reduce the likelihood that work for forming the positive electrode current collector 11 is restricted by the other members. Accordingly, it is possible to improve the positional accuracy of the positive electrode current collector 11. Furthermore, it is possible to improve workability when forming the positive electrode active material layer 15.

The manufacturing method of the all-solid-state battery 1 of the above-described embodiment includes the process of forming the positive electrode active material layer 15 on the positive electrode current collector 11, the process of forming the solid electrolyte layer 30 so that it extends from the top of the positive electrode active material layer 15 to the top of the positive electrode current collector 11, and the process of forming the insulating member 40 so that it extends from the top of the positive electrode current collector 11 to the top of the solid electrolyte layer 30.

According to the above manufacturing method, it is possible to form the second inclined portion 32 in the solid electrolyte layer 30 and cover the second inclined portion 32 with the insulating member 40. Furthermore, since the positive electrode active material layer 15 is formed before the insulating member 40, it is possible to form the positive electrode active material layer 15 on the positive electrode current collector 11 without being hindered by the insulating member 40. Accordingly, it is possible to improve the positional accuracy of the positive electrode current collector 11. Furthermore, it is possible to improve workability when forming the positive electrode active material layer 15.

### Modification of Embodiment

An all-solid-state battery 1 according to a modification of the embodiment will be described with reference to FIG. 4. The same components as those in the all-solid-state battery 1 according to the embodiment are assigned with the same reference signs, and explanation thereof may be omitted.

As shown in FIG. 4, an all-solid-state battery 200 does not include the insulating member 40.

In a ZY cross section, a negative electrode current collector 21 has, in its portion overlapping with a second inclined portion 32 in the Z direction, a fourth inclined portion 24 that is inclined toward a positive electrode current collector 11 side as approaching the outside in the Y direction. The fourth inclined portion 24 (specifically, the entirety of the fourth inclined portion 24) is disposed outside a region that overlaps with a positive electrode active material layer 15 in the Z direction. The fourth inclined portion 24 extends substantially parallel to a direction in which the second inclined portion 32 extends.

In the ZY cross section, a negative electrode active material layer 25 has, in its portion overlapping with the second inclined portion 32 in the Z direction, a fifth inclined portion 26 that is inclined toward the positive electrode current collector 11 side as approaching the outside in the Z direction. The fifth inclined portion 26 is adjacent to the fourth inclined portion 24. The fifth inclined portion 26 (specifically, the entirety of the fifth inclined portion 26) is disposed outside a region that overlaps with the positive electrode active material layer 15 in the Z direction. The fifth inclined portion 26 extends substantially parallel to the direction in which the second inclined portion 32 extends.

Note that the fourth inclined portion 24 and the fifth inclined portion 26 together are referred to as a "negative electrode inclined portion 28". A negative electrode layer 20 has, in its portion overlapping with the second inclined portion 32 in the Z direction, the negative electrode inclined portion 28 that is inclined toward the positive electrode current collector 11 side as approaching the outside in the Y direction.

In the ZY cross direction, an intermediate layer 50 has, in its portion overlapping with the second inclined portion 32 in the Z direction, a sixth inclined portion 51 that is inclined toward the positive electrode current collector 11 side as approaching the outside in the Y direction. The sixth inclined portion 51 is adjacent to the fifth inclined portion 26. The sixth inclined portion 51 (specifically, the entirety of the sixth inclined portion 51) is disposed outside a region that overlaps with the positive electrode active material layer 15 in the Z direction. The sixth inclined portion 51 extends substantially parallel to the direction in which the second inclined portion 32 extends.

In the ZY cross section, the first inclined portion 18, the second inclined portion 32, the fourth inclined portion 24, and the fifth inclined portion 26 overlap in a direction orthogonal to a direction in which the first inclined portion 18 extends.

According to the above configuration, lithium ions released from the first inclined portion 18 move in a straight line, and can reach the negative electrode inclined portion 28 via the solid electrolyte layer 30, and the sixth inclined portion 51 of the intermediate layer 50. Accordingly, lithium can be deposited appropriately even in parts of the negative electrode layer 20 that are not aligned with the positive electrode active material layer 15 in the Z direction. Accordingly, in the negative electrode layer 20, lithium can be dispersed and deposited, and therefore it is possible to suppress local deposition of lithium.

The present invention is not limited to the configuration of the above-described embodiment, and can be appropriately modified and applied within the scope that does not change the gist of the present invention. Note that the present invention also includes a combination of two or more of the individual desirable configurations described in the above-described embodiment.

What is claimed is:

1. An all-solid-state battery comprising:
a positive electrode layer including a positive electrode current collector and a positive electrode active material layer;
a negative electrode layer including at least a negative electrode current collector; and
a solid electrolyte layer disposed between the positive electrode layer and the negative electrode layer,
wherein a direction in which the positive electrode layer and the negative electrode layer are laminated via the solid electrolyte layer is defined as a lamination direction,
a direction among directions orthogonal to the lamination direction is defined as a first direction,
a direction orthogonal to the lamination direction and the first direction is defined as a second direction,
a side in the second direction away from a central portion in the second direction of the all-solid-state battery is defined as an outside in the second direction, and
the positive electrode current collector has a tab portion that extends in the first direction, and
wherein in a cross section orthogonal to the lamination direction and the second direction,
a dimension in the second direction of the positive electrode active material layer increases toward a positive electrode current collector side,
the solid electrolyte layer covers an end portion of the positive electrode active material layer closer to the outside in the second direction,
the positive electrode active material layer has a surface that is in contact with the solid electrolyte layer, and the surface has a first inclined portion that is inclined toward the outside in the second direction as approaching the positive electrode current collector side,
the solid electrolyte layer has a surface that is in contact with the positive electrode active material layer and a surface that is opposite to said surface and has a second inclined portion that is inclined toward the outside in the second direction as approaching the positive electrode current collector side, and
an end portion of the second inclined portion closer to a negative electrode layer side is positioned more proximal to the outside in the second direction than an end portion of the first inclined portion closer to the negative electrode layer side.

2. The all-solid-state battery according to claim 1, further comprising:
an insulating member that is disposed around the positive electrode active material layer,
wherein in the cross section orthogonal to the lamination direction and the second direction,
the insulating member covers the second inclined portion.

3. The all-solid-state battery according to claim 1, wherein the end portion of the second inclined portion closer to the negative electrode layer side is positioned more proximal to the outside in the second direction than an end portion of the first inclined portion closer to the positive electrode current collector side.

4. The all-solid-state battery according to claim 2, wherein in the cross section orthogonal to the lamination direction and the second direction, when a region between the positive electrode current collector and the negative electrode layer that are adjacent to each other is divided into two equal regions in the lamination direction, one region of the two equal regions includes a region in which the insulating member and the solid electrolyte layer overlap with each other in the lamination direction, a region in which the solid electrolyte layer does not overlap with the positive electrode active material layer nor the insulating member in the lamination direction, and a region in which the positive electrode active material layer and the solid electrolyte layer overlap with each other in the lamination direction.

5. The all-solid-state battery according to claim 1, wherein
in the cross section orthogonal to the lamination direction and the second direction,
a ratio of a length in the second direction between the end portion of the second inclined portion closer to the negative electrode layer side and an end portion of the first inclined portion closer to the positive electrode active material layer side to a dimension in the second direction of the first inclined portion is 0.01 or more and 5000 or less.

6. The all-solid-state battery according to claim 2, wherein
in the cross section orthogonal to the lamination direction and the second direction,
a ratio of a length in the second direction between the end portion of the second inclined portion closer to the negative electrode layer side and an end portion of the first inclined portion closer to the positive electrode active material layer side to a dimension in the second direction of the second inclined portion is 0.01 or more and 5000 or less.

7. The all-solid-state battery according to claim 1, wherein
in the cross section orthogonal to the lamination direction and the second direction,
the negative electrode layer has, in a portion thereof overlapping with the second inclined portion in the lamination direction, a negative electrode inclined portion that is inclined toward the positive electrode current collector side as approaching the outside in the second direction.

8. A method of manufacturing the all-solid-state battery according to claim 1, the method comprising:
forming the positive electrode active material layer on the positive electrode current collector; and
forming the solid electrolyte layer so that the solid electrolyte layer extends from a top of the positive electrode active material layer to a top of the positive electrode current collector.

9. A method of manufacturing the all-solid-state battery according to claim 2, the method comprising:
forming the positive electrode active material layer on the positive electrode current collector;
forming the solid electrolyte layer so that the solid electrolyte layer extends from a top of the positive electrode active material layer to a top of the positive electrode current collector; and
forming the insulating member so that the insulating member extends from the top of the positive electrode current collector to a top of the solid electrolyte layer.
